(19) United States
(12) Patent Application Publication
(10) Pub. No.: US 2016/0136943 A1
(43) Pub. Date: May 19, 2016

(54) Squeegee Blade Holder For Use In Screen Printing

(71) Applicant: ROBERT JOHN SIEVERT, Mt. Carroll, IL (US)

(72) Inventor: ROBERT JOHN SIEVERT, Mt. Carroll, IL (US)

(21) Appl. No.: 14/944,132

(22) Filed: Nov. 17, 2015

Related U.S. Application Data
(60) Provisional application No. 62/081,495, filed on Nov. 18, 2014.

(51) Int. Cl. B41F 15/44

(52) U.S. Cl. CPC B41F 15/44

(57) ABSTRACT

A manually operated squeegee blade holder for use in screen printing includes two extensions and multiple support platforms.

The extensions function as handgrips held by an operator to pull or push a squeegee blade retained by the holder, across a screen for the purpose for pressing ink through a screen onto substrate material.

The support platforms brace the blade holder when placed down on a surface. The support platforms protect the blade and reduce the unintended transfer of ink from one surface to another.

### NON-PROVISIONAL APPLICATION FOR UNITED STATES PATENT

This application claims priority of Provisional Application No. 62/081,495 filed on Nov. 18, 2014.

### BACKGROUND OF THE INVENTION

Screen printing, frequently referred to as silk screening, is a process of forcing ink through a stenciled screen by the applied pressure of a squeegee blade. This process is commonly used for imprinting tee shirts and other items including general apparel, flags, banners, posters, art prints, signage and more.

A squeegee blade holder, also referenced as a squeegee holder or holder, controls the functions of an attached squeegee blade, referred to as a blade.

A method of creating an imprint requires an operator to pull or push (operator preference) a squeegee holder fitted with an attached blade, across the topside of a silk screen, synthetic screen or mesh like material, concurrently applying a downward pressure to the topside of the holder, referenced as a print stroke, whereby said pressure transfers through the holder to the print edge of the blade, forcing ink, plastic, paint, pigment, liquid or semi-liquid substances, referred as ink, through the unblocked areas of said screen to the topside of substrate material, including organic and synthetic fabric, paper, press board, glass, metal, plastic and other workable materials.

The conventional squeegee holder commonly made from wood, is oblong in shape measuring approximately 10.16 cm (4 inches) in height, 2.54 cm (1 inch) in width, and the length varies to accommodate the width of the print area. For instance, the conventional width for printing tee shirts measures from 7.62 cm (3 inches) to 30.48 cm (12 inches).

As viewed from an end side of the linear holder, a teardrop shape forms the upper portion and the lower portion has flat sides that comprise about one third the height, as illustrated in a U.S. Pat. No. 5,321,868, dated Jun. 21, 1994.

The bottom side includes a blade receptacle slot that retains a squeegee blade.

The conventional holder is held with both hands placed horizontally adjacent with the mid-palms facing down and fitting snugly against the narrow topside of the squeegee holder.

In use, the operator applies pressure using the fingertips to press down on the side that faces away from the operator and the thumb tips to apply a reverse pressure on the side facing the operator.

This method requires the hands to grip past the vertical axis of the holder, whereby forcing the adjoining wrists to bend. To what degree, is dependent upon the angle of approach when executing a print stroke. The angle varies as a result due to relationship between both the height of the operator and the screen height, the lesser the disparity, the greater the bend.

In addition, this method substantially uses small muscles in the hands and forearms to grip the holder and apply the downward force. In addition, the precision grip constricts and pinches the mid-palms, whereby compressing the nerves, ligaments, tendons and other tissues that pass through the palms or the wrists, including the median nerve passing through the carpal tunnel in the wrist. The print stroke is a repetitive action and over time, said conditions can cause operator pain and injury, as referenced in U.S. Pat. No. 5,321,868.

As part of the printing process, the holder is placed on the surface of a screen where ink is normally present and on other surfaces where ink should not be present.

The round shape of the topside and the linear flat sides of the lower portion hinders the ability to set the holder on either surface without the assistance of an accessory brace or braces to prevent potential problems that includes damage to the blade.

The braces also prevent contamination, defined as the unintentional transfer of wet ink from one surface to another surface, and the presence of wet ink on a surface where ink should be or should not be present.

Critical areas to protect from contamination include areas that frequently interact with the hands of the operator. Importantly, both hands must remain clean at all times to prevent transferring ink directly and indirectly onto the substrate or other unintended surfaces.

### BRIEF SUMMARY OF THE INVENTION

A manually operated squeegee blade holder for use in screen printing preferably embodies a lower piece and an upper piece.

The lower piece retains a squeegee blade and the upper piece includes two extensions, whereof the extensions are hand held using one hand for each extension. The portion of the extension gripped by the hand is also referred to as a handgrip, and by the use thereof, an operator controls the functions of the holder.

Some alternative embodiments include a middle piece, which is used to join the lower and upper pieces together.

Beneficial to the operator, the extensions are ergonomically positioned to help the hand and adjoining wrist form a straight skeletal alignment, thereby avoiding compression at the wrist. As a further benefit, the assigned posture employs mostly the larger muscle groups in the upper arms, chest and shoulders to do the work, rather than smaller muscles in the hands and wrists, which are substantially used to operate the conventional holder.

More specifically, the ergonomic properties mentioned herein, help in preventing musculoskeletal problems including discomfort, fatigue, pain and other distressing conditions, as well as the potential development of Carpal Tunnel Syndrome.

In order to achieve a successful imprint, the blade (7) must be correctly angled to force ink through a screen. Constructively, the angle required to effectively press ink through a screen is established at the same time, an ergonomic angle is also established.

Several additional problems related to the conventional holder are addressed, including the accidental damage to a squeegee blade and the unintentional transference of ink from one surface to another, especially to the handgrip portion of an extension.

The holder is designed to reduce frequent occurrences of these problems by the inclusion of multiple support platforms that serve as braces, which specifically position the holder when placed on appropriate surfaces. The pre-arranged placements angle the holder so that damage and contamination are minimized.

### BRIEF DESCRIPTION OF THE DRAWINGS

FIG. 1 is a front side elevational view of a preferred embodiment showing a lower piece retaining a squeegee blade, and an upper piece including two extensions.

FIG. 1A is an elevational partial view of FIG. 1 showing only the lower piece.

FIG. 1B is an elevational partial view of FIG. 1 showing only both extensions of the upper piece.

FIG. 2 is an elevational view of an alternative embodiment including a middle piece.

FIG. 2A is an elevational partial view of FIG. 2 showing only the middle piece.

FIG. 3 is a rear side elevational view of FIG. 1.

FIG. 4 is a top plan view of FIG. 1.

FIG. 5 is a bottom plan view of FIG. 1.

FIG. 6 is an elevational view of FIG. 1 shown without a squeegee blade.

FIG. 7 is a left side elevational view of FIG. 1.

FIG. 8 is a right side elevational view of FIG. 6.

FIG. 9 is a right side elevational view of FIG. 1, positioned for use.

FIG. 9A is an enlarged partial view of FIG. 9 showing the blade area.

FIG. 10 is a right side elevational view representing the embodiment in FIG. 1, not in use, resting on the front side.

FIG. 11 is a right side elevational view representing the embodiment in FIG. 1, not in use, resting on the rear side.

FIG. 12 is a right side elevational view of an additional preferred embodiment.

FIG. 13 is a right side elevational view of FIG. 12, resting on the front side.

FIG. 14 is a right side elevational view of an alternative embodiment.

FIG. 15 is a right side elevational view of FIG. 14, resting on the front side.

### DETAILED DESCRIPTION OF THE INVENTION

Various appropriate embodiments are described more fully hereinafter with reference to the accompanying drawings, some of which, but not all embodiments are shown in the Figures. In fact, the present invention may be embodied in many different forms and configurations. Therefore, the set forth embodiments herein described and shown should not be construed as limited or complete in concept and scope.

The disclosed subject matter is a manually operated squeegee blade holder for use in screen printing.

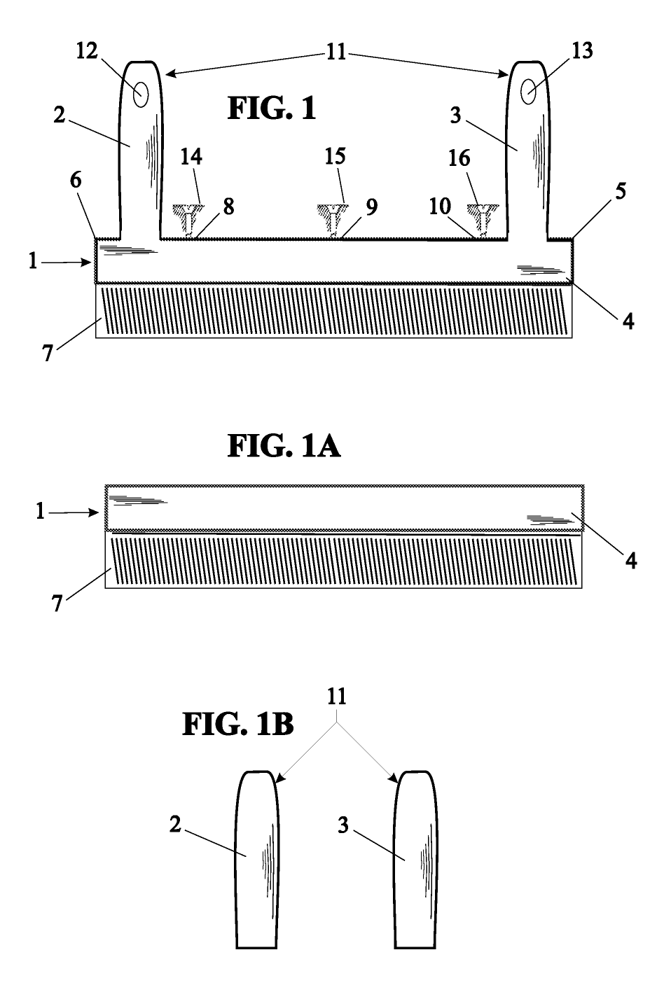

The body of the holder includes a whole undivided unit, made as one undivided unit or made using multiple pieces, platforms and various components joined thereafter, including a lower piece (1) FIG. 1, and new to the art is a middle piece (211) FIG. 2, an upper piece (11) FIG. 1 and multiple support platforms (5,6,12,13) FIG. 1 and (32,33) FIG. 3.

Divided pieces are made individually or two pieces are made as one undivided unit, joined thereafter to the other piece. An example is a middle piece (211) and upper piece (11) made as one undivided unit, thereafter joined to the lower piece (1).

The body and components are made using polymers including plastic and resin, metals including steel and aluminum, composite materials including carbon, or other workable materials including wood, rubber and vinyl, or in combination.

Shown in FIG. 1 is a representation of a preferred embodiment made as one undivided unit. The view faces the linear front side (4) as the holder sets upright, the front side (4) facing the operator during use. Included is a lower piece (1) and an upper piece (11), the upper piece (11) having two extensions (2,3) that function as handgrips and are used to control the maneuverability and operations of the holder, therefore the attached squeegee blade (7).

One method of use to create an imprint includes an operator holds one handgrip in each hand with the palms facing inward towards each other. The fingers and thumb wrap around a handgrip in the same manner one holds a bicycle handlebar grip.

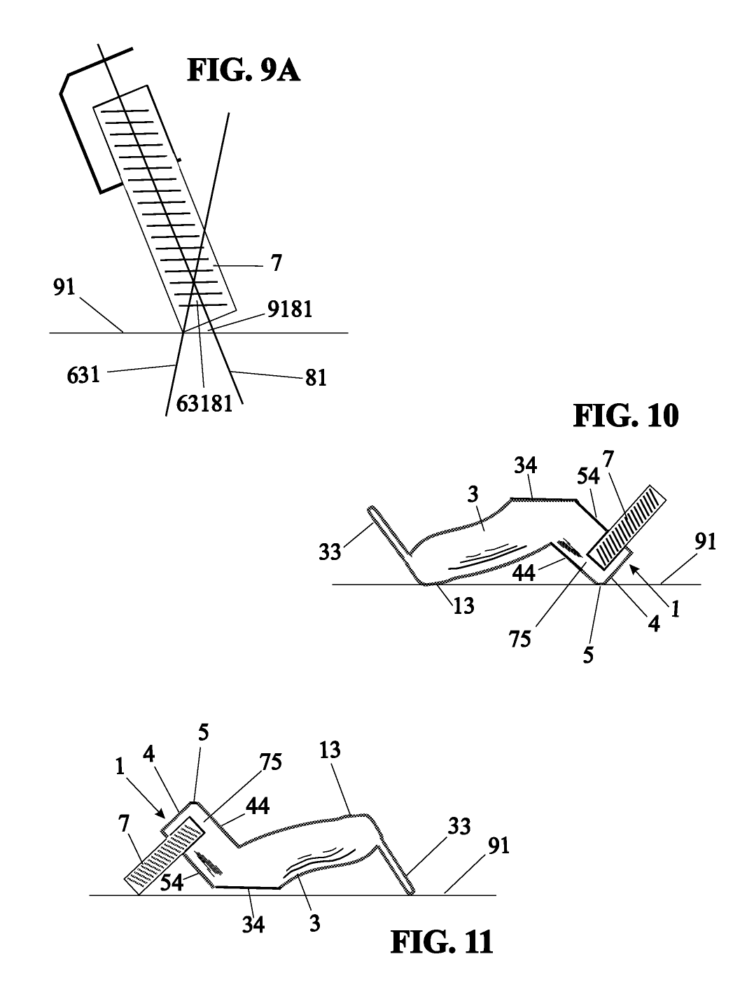

In preparation for a print stroke, an operator pulls or pushes the holder to lightly coat the screen (91) FIG. 9 with ink.

Next, the operator again pulls or pushes the holder across the screen (91), now applying a downward thrust frequently exceeding fifteen pounds of pressure per square inch that forces ink through the screen (91) onto a substrate.

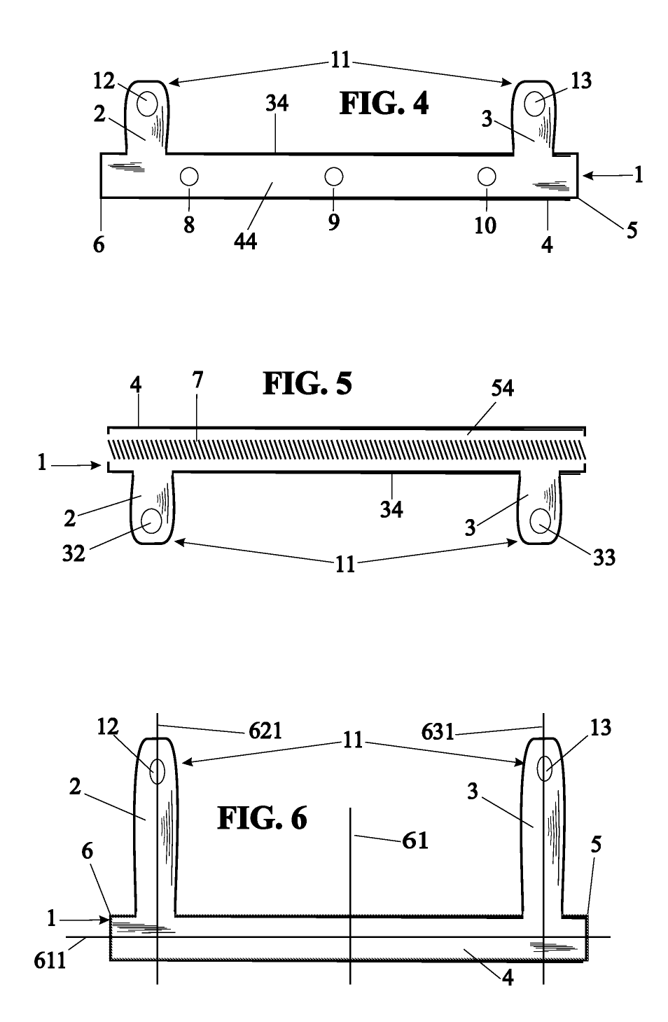

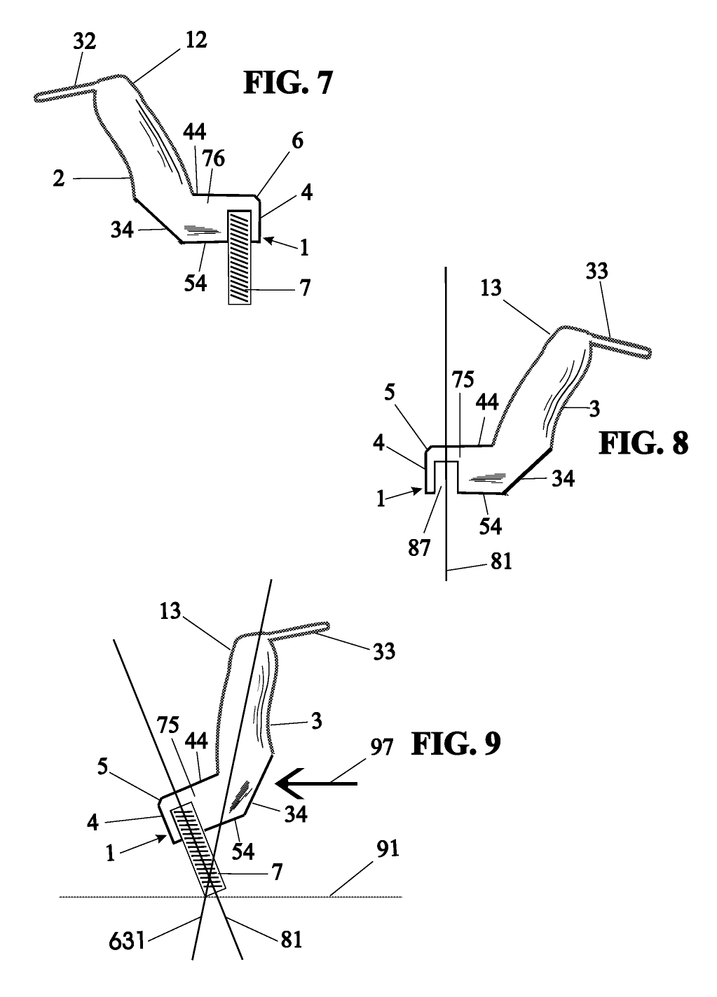

The elongated lower piece (1) receives and secures an elongated squeegee blade (7). The lower piece (1) has one left end side (76) FIG. 7, one right end side (75) FIG. 8, and an elongated mid-section. The external linear sides of the elongated mid-section comprise the front side (4), rear side (34) FIG. 3, topside (44) FIG. 4, and bottom side (54) FIG. 5 of the lower piece (1). Whereas, the sides of the lower piece (1) are used to reference various views of the body, pieces, platforms and components thereof.

The preferred embodiment in FIG. 1 shows the location of the platforms (5,6,12,13) and illustrates a blade (7) attached to the lower piece (1) by the insertion of three screws (14,15,16), only shown in FIG. 1, passing through three openings (8,9,10) located on the topside (44).

The openings (8,9,10) provide access to secure a blade (7) to the blade receptacle slot (87) FIG. 8.

Other appropriate ways for securing a blade (7) include two or more screws pass through only the topside (44), only the front side (4), or only the rear side (34). The blade (7) can also be fastened using components including nuts and bolts (211-6A,211-6B,211-7A,211-7B), as represented in FIG. 14 and described hereinafter.

An extension (2,3) has one end, another end, and a straight and or curved elongated mid-section. One end is joined to the lower piece (1) or to a middle piece (211) and the other end is not joined. The extensions (2,3) shown in FIG. 1 join along the rear side (34) and topside (44) of the lower piece (1).

FIG. 1A is a partial view of FIG. 1 showing only the lower piece (1) and a blade (7).

FIG. 1B is a partial view of FIG. 1 showing only the two extensions (2,3) of the upper piece (11).

FIG. 2 illustrates an alternative embodiment that includes a middle piece (211). Shown is a composite of various appropriate components capable of functioning independently or in combination. The components depicted consist of an extension connector bar (211-1) which joins the two extensions (2,3) together, two vertical connecting rods (211-2A,211-2B), two slanted connecting rods (211-3A,211-3B) and one connecting cross member (211-4).

An extension connector bar (211-1) is appropriately configured to include multiple points of attachment to join an extension (2,3) to the connector bar (211-1). One method of attachment includes forming several holes linearly along the bar (211-1) so the base of an extension (2,3), of which has a smooth or threaded, hole in or solid bolt, post or pin, passes through the bar (211-1) and is secured thereat using a fastener including a nut, pin or other appropriate retainers, some of which are mentioned herein.

Another method includes a bar (211-1) having a linear channel whereby the base of each extension (2,3) slides along to affix at a variable points, using a conventional lock and slide mechanism. Thereby, these or other methods allows for the linear distance between the two extensions (2,3) to adjust so the lateral downward pressure remains equally distributed to accommodate for various lengths of the lower piece (1).

The other components shown including the rods (211-6A,211-6B,211-7A,211-7B), and cross member (211-4) join to the lower piece (1) in several ways which include forming a smooth, grooved, tapered or threaded lower portion of a connector rod (211-6A,211-6B,211-7A,211-7B) that is received by a compatible counterpart receptacle hole or slot in the lower piece (1). Thereat, the two are secured using a variety of devices and or substances mentioned herein or by other conventional or non-conventional methods including devices and substances not mentioned or shown herein.

Other components appropriate for making a middle piece (211) include connectors capable of joining the lower piece (1) and the extensions (2,3) of the upper piece (11) as one unit. An example includes an angled bracket, thereof the lower portion includes a cylindrical, rectangular, triangular or forked form and the upper portion is formed to serve as an inner liner to an extension (2,3), or is preferably formed to resemble the outer shape of an extension (2,3). Thereby, the upper portion of a middle piece (211) and an extension (2,3) can be one in the same. In fact, the middle piece (211) and both extensions (2,3) can be made as one undivided unit thereafter joined to the lower piece (1).

However, the extensions (2,3) are capable of joining to the lower piece (1) without the need of a middle piece (211), as revealed in FIG. 1. Preferred embodiments are made without requiring a middle piece (211) and some alternative embodiments are made using a middle piece (211).

FIG. 2A is a partial view only showing the middle piece (211), as illustrated in FIG. 2.

FIG. 3 is a view of the rear side (34) of FIG. 1 showing the locations of two platforms (32,33).

FIG. 4 is a view shown from the top side (44) of FIG. 1 including three screw holes (8,9,10).

FIG. 5 is a view from the bottom side (54) of FIG. 1 including a retained blade (7).

The drawings are shown in two-dimensions, thereby any drawing depicting a geometric plane is best viewed from a linear end of said plane. Since a plane is seen as a line, planes set forth are shown and described as lines.

FIG. 6 is a view of the preferred embodiment as shown in FIG. 1 without a squeegee blade (7) in place. Shown is the vertical centerline (61) and illustrated are the perpendicular angles created at the intersection of the linear vertical axis lines (621,631) and a line (611) which represents the horizontal. In this embodiment, the axes (621,631) for both extensions (2,3) form straight lines.

Ref. Nos. (61,611) are only shown in FIG. 6, and (621,631) only in FIGS. 6.9,9A).

However, other appropriate embodiments including preferred and alternative embodiments can include a curved axis (631,632), defined by the curved linear form of an extension (2,3) similar in shape to a crescent moon. The curve bends in the direction towards the rear side (34). Additionally, an un-joined end of a straight or curved extension (2,3) can slant inward towards the centerline (61), preferably by ten degrees or less. Appropriately and in some preferred embodiments, the direction of the bend can slightly point towards the centerline (61).

FIG. 7 is a view from the left end side (76) of FIG. 1 illustrating the elongation of platform (32), also representing (33). Whereas in the drawings submitted, divided along the vertical centerline (61), one side is a mirror image of the other side. Hereinafter, a reference to one piece, platform, or component as viewed from one end side is considered a reference to the other mirrored piece, platform, or component as viewed from the other end side.

Although, only one of the represented platforms (32,33) is required to provide the necessary support to properly brace the holder, therefore, appropriate embodiments can include asymmetrical sides.

Support platforms, also referred to as platforms, include flat and curved surfaces, elongated protrusions and other forms including various sizes, which brace the holder in self-standing positions, thereby providing protection and prevention, as described hereinafter.

FIG. 8 is a view showing the right end side (75) of FIG. 6 illustrating a blade receptacle slot (87), the vertical axis (81) of the blade receptacle slot (87), and elongated platform (33), representing (32,33). Ref. (81) is only shown in FIGS. (8,9,9A).

The view in FIG. 9 is a right end side (75) view of FIG. 1 indicating the travel direction (97), only shown in FIG. 9, and the angle of the body employed for executing a print stroke.

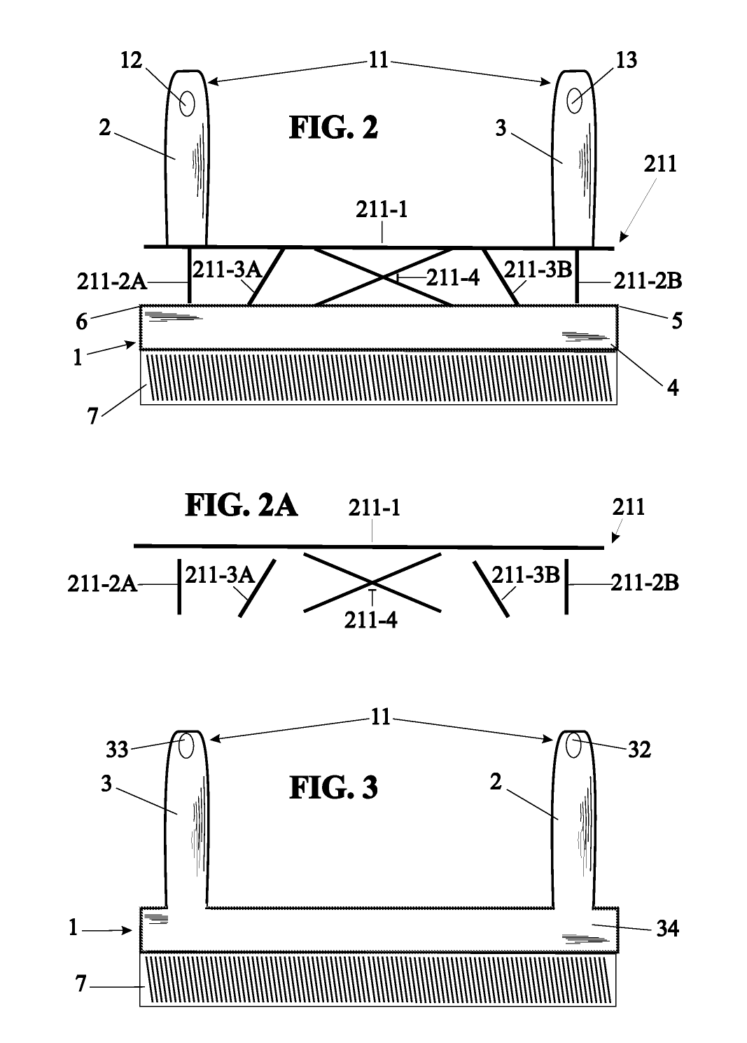

The horizontal line (91) is intended to represent the surface within the framed area of a screen where ink should be present, as illustrated in FIGS. 9, 9A and 11, and also is intended to represents surfaces outside of the framed area where ink should not be present, as illustrated in FIGS. 10, 13 and 15.

Shown is linear axis (631 of 3), also representing (632 of 2), intersecting with line (91). Preferably, axes (631,632) slant in the direction towards the linear rear side (34). In various alternative configurations that use a middle piece (211), the linear axes (631,632) are either slanted or perpendicular to the horizontal (611).

FIG. 9A is an enlarged partial view of the blade (7) area shown in FIG. 9, including the lower acute angle (63181) formed by the intersection of axis (631) and axis (81), also representing (632 and 63281).

The angle (63181) is about thirty-three degrees, however, is subject to change due to various appropriate configurations between the lower (1), middle (211) and upper piece (11) or in combination.

The upper acute angle (9181) at the intersection of the line (91) and (81) is identical to the angle along the print edge of the blade (7). Appropriate for the angle (9181) is about twenty degrees from the vertical, however, is subject to variances resulting from different viscosities of assorted inks, ambient temperature, and other conditions that affect the flow of ink.

As illustrated in FIG. 10, one purpose of the platforms (5,6,12,13) includes placing a holder on an uncontaminated surface supported by the platforms (5,6,12,13) in order to protect the blade (7) from damage, whereas a small cut or notch along the print edge renders the blade (7) useless. In this example, ink is considered not present on the blade (7).

Another purpose for the same position shown FIG. 10 is to reduce contamination, whereas during the print operation ink should be present on the blade (7). Therefore, when a contaminated blade (7) is placed on an uncontaminated surface, contamination thereat is a real possibility, so the need for prevention is imperative.

A method for placing the holder with or without a contaminated blade (7) on an uncontaminated surface (91) includes an operator faces the front side (4) holding both extensions (2,3) and tilts the un-joined ends of the extensions (2,3) counter clockwise and continues to rotate the holder until the ends of the platforms (5,6,12,13) point down in the direction of a uncontaminated surface (91).

The holder is then placed on the surface (91) resting on the platforms (5,13), representing (5,6,12,13), which supports the blade (7) in an upward direction, thereby avoiding blade (7) contact with the surface (91). Consequently, chances of damage and contamination are substantially minimized.

The platforms (5,6,12,13) as illustrated have flat surfaces. The placement and shape of each platform (5,6,12,13) can vary along the front side (4) of the lower piece (1) and along an extension (2,3) to accomplish the same result, as shown in FIGS. 13 and 15.

FIG. 11 illustrates one purpose for the platforms (32,33). Shown is the preferred embodiment of FIG. 10 resting on the rear side (34) facing what is considered to be a contaminated screen (91), supported by the blade (7) and platform (33), representing (32,33). Both platforms (32,33) function as braces that support the handgrip portion of an extension (2,3) from contacting the screen (91), thereby further reducing the risk of possible contamination.

A method of use that employs the platforms (32,33) includes an operator hand holds both extensions (2,3) facing the front side (4). The operator rotates the holder clockwise until the rear linear edge of the attached blade (7) and the ends of the platforms (32,33) face towards the contaminated screen (91), then setting the holder on the screen (91) to rest on both the linear blade (7) edge and on the ends of the platforms (32,33).

An alternative platform design, not shown, replaces platforms (32,33) with a single component resembling a thin metal wire, made from rigid material having little, but some flexibility, and has one end, and another end, and an elongated mid-section having a flat, curved, or flat and curved outer surface.

The linear form of the platform is similar to a U-shape, preferably measuring about 0.16 cm to about 0.32 cm, ( 1/16 to ⅛ inch) in width or diameter. The length exceeds the distance that lies linearly between the two extensions (2,3), preferably by no more than 25.40 cm (10 inches). The bottom portion of the U-shape makes contact with the surface (91) and the two inner bottom corners include acute, perpendicular or obtuse angles.

One un-joined end of the platform is joined to an extension (2,3) and the other un-joined end joins to the other extension (2,3) using various techniques including a bend of about a ninety degrees near each end, thereby allowing the short portion measuring 1.27 cm (½ inch) or less that extends beyond the bend, to insert into a pre-formed hole preferably disposed near the un-joined end of each extension (2,3). Whereby, a notch formed near an insertion hole, allows the platform to seat down into said notch and making use of the proper tension created by a platform pressing against an extension (2,3), resulting from the distance between the platform ends being less than the width of the adjoining extensions (2,3), sufficiently locks the platform in place.

A set of notches comprises two notches, one notch per extension (2,3). The direction of a notch set determines the angle of the platform.

One appropriate embodiment includes two sets of notches, one set positions the handgrips up and away from a surface (91) and the other set retracts the platform, thus creating a thinner profile for storage.

Preferred measurements for appropriate pieces (1,11,211) and platforms (5,6,12,13,32,33) as shown In FIGS. 1-11 and aforementioned, include a lower piece (1) measuring in height about 2.54 cm (1 inch), in width about 2.54 cm to 3.81 cm (1 inch to 1½ inches), the preferred length is about 20.32 cm to about 45.72 cm (8 inches to 18 inches), although appropriate lengths can vary from about 15.24 cm to about 101.6 cm (6 inches to 40 inches).

The blade receptacle slot (87) is open at both ends and measurements for the blade slot (87) that accommodates a conventional squeegee blade includes a height of about 1.59 cm (⅝ inch) and width of about 0.95 cm (⅜ inch).

An extension (2,3) is embodied in many different appropriate configurations, and the embodiments set forth herein should not be construed as limited. Indeed, forms and configurations capable of being hand held include polygons having regular and irregular shapes and or curves having circular arcs and not circular arcs.

As described and shown, the outer surface of an extension (2,3) is considered contoured to ergonomically fit the human hand. Furthermore, all considerations and outer surface design shapes are preferably executed for the comfort and ergonomic benefit of the operator.

An extension (2,3) is made as one whole undivided unit or is made using divide components joined thereafter. Preferable extensions (2,3) have an outer surface measuring about 11.43 cm to about 12.70 cm (4 to 5 inches) in length and about 3.18 cm to about 4.45 cm (1¼ to 1¾ inch) in width and or diameter.

Appropriately, an extension (2,3) is also formed to serve as an inner liner, shaped as a protrusion, thereafter encompassed by an outer liner forming the outer surface that includes one or more components which join to the sides of, or slip over said inner liner, together comprising an extension (2,3).

Examples of appropriate inner liners include cylindrical, rectangular or triangular post, or similar shapes, to which a form resembling for instance, a rubber or vinyl conventional bicycle handlebar grip, slips over to encompass the inner liner.

The extensions (2,3) are joined to the topside (44), front side (4), or rear side (34) of the lower piece (1) or in combination of said sides, or to one side or a combination of sides of a middle piece (211).

A preferred configuration of the extensions (2,3) is a side-by-side collinearity placement, linearly separated by about 15.24 cm to about 71.12 cm (6 inches to 28 inches), each equally distanced from the centerline (61). Other appropriate embodiments include extensions (2,3) that are not collinear and or unequally distanced from the centerline (61).

Platforms that support the extensions (2,3) include one or more elongated platforms (32,33), preferably the linear is cylindrical or polygon in shape, measuring about 5.08 cm (2 inches) in length and a width or diameter of about 0.32 cm (⅛ inch).

A platform (32,33) end preferably has a flat or curved form avoiding a pointed edge, whereby minimizing potential damage to the surface of the screen (91).

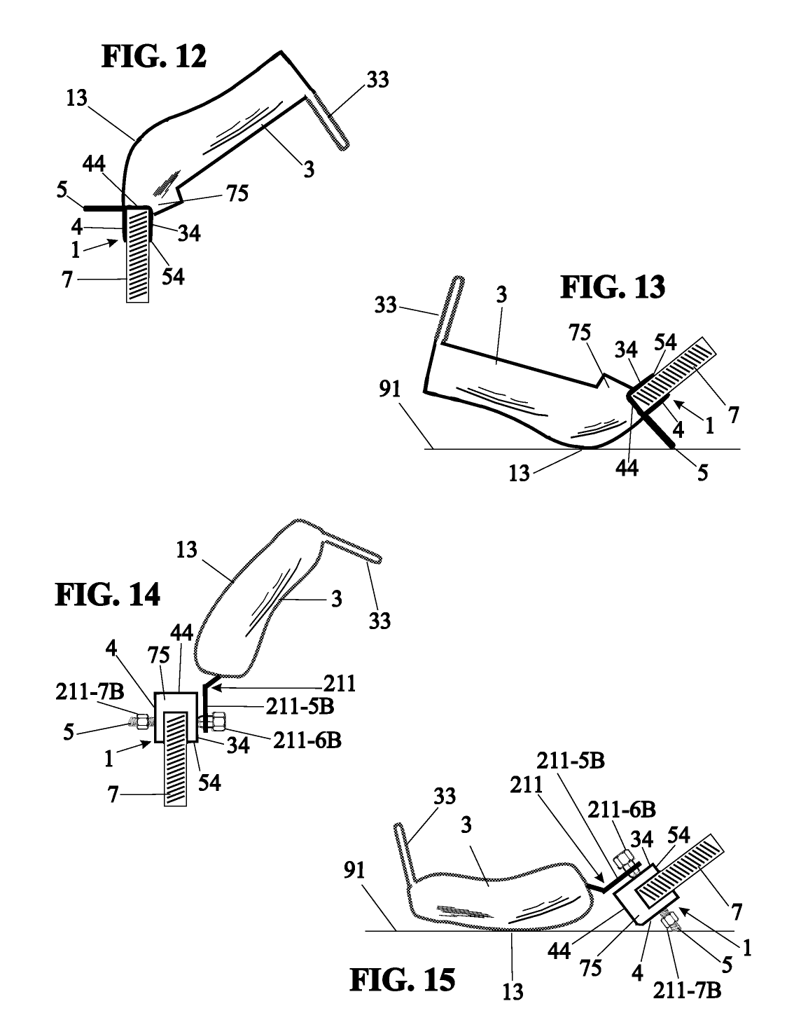

FIG. 12 is a right end side (75) view, representing (75,76), showing a preferred modified embodiment that shares many of the same properties with the embodiment in FIG. 1.

Modifications include platforms (5,6) as elongated protrusions extending from the front side (4), measuring about 1.59 cm (⅝ inch) long, and 0.32 cm (⅛ inch) in width or diameter. The lower piece (1) is less complicated and lighter weight, measuring in height and width of about 1.91 cm (¾ inch) respectfully, for both measurements.

The extensions (2,3) are formed to include a humpback portion along the front side (4) and the flat platforms (12,13) are disposed along the spine of the humpback portion.

The front side (4) view of FIG. 12, not shown, has substantially the same profile as the embodiment shown in FIG. 1.

FIG. 13 shows the preferred embodiment of FIG. 12 placed on the front side (4) resting on platforms (5) and (13), representing (5,6,12,13).

The embodiment shown in FIGS. 12 and 13 rests on the rear side (34) in the same manner as the embodiment shown in FIG. 11.

The shape of the lower portion for the conventional squeegee blade holder as previously referenced by U.S. Pat. No. 5,321,868, is still the basic design currently used for most all conventional squeegee holders sold in present day.

The lower piece (1) of the present invention is also common with the prior art noted in the previous paragraph, in so much as both included an elongated form and disposed along the bottom side (54) having an elongated squeegee blade receptacle slot (87), thereof retains an elongated squeegee blade (7).

An appropriate component used for making a lower piece (1) is a modified conventional squeegee holder made from materials including wood or metal.

Modifications include removing the upper teardrop portion of the conventional holder using a cutting tool, leaving the flat sided lower proportion measuring about 2.54 cm to about 6.35 cm (1 to 2½ inches) tall, whereas, the remaining piece is the portion that retains the blade (7).

Another appropriate form for the lower piece (1) includes making a close facsimile of the lower piece (1) as described in the previous paragraph.

An alternative embodiment of the drawing shown in FIG. 1 as viewed in FIG. 14 from the right end side (75), also representing (76), includes a lower piece (1) formed to resemble the lower pieces (1) forementioned in the two previous paragraphs. In this particular embodiment shown in FIGS. 14 and 15, the middle piece (211) includes two independent brackets (211-5A,211-5B), shown is bracket (211-5B). Each bracket (211-5A,211-5B) has a lower portion and an upper portion. Illustrated is extension (3) joined to the upper portion of bracket (211-5B), also representing extension (2) joined to (211-5A).

The lower portion of the bracket (211-5A,211-5B) is rectangular having one linear side that fits to the rear side (34) of the lower piece (1), and is fastened to the rear side (34) by inserting a bolt (211-6A,211-6B), shown is (211-6B), through a predrilled hole in the pieces and components to be joined, including the brackets (211-5A,211-5B), the rear side (34) and front side (4), also the retained squeegee blade (7), thereat, is secured by a fastener including a nut (211-7B), also representing (211-7A).

Whereby, this method secures the extensions (2,3) to the lower piece (1) and at the same time secures the blade (7) to the blade slot (87). As shown, the upper portion of the bracket (211-5B) and the adjoining extension (3) are one unit, also representing (211-5A and 3).

The front side (4) view of the embodiment in FIG. 14, not shown, has substantially the same profile as the embodiment shown in FIG. 1.

Shown in FIG. 15, the embodiment of FIG. 14 is placed on the front side (4) resting on platforms (5) and (13), representing (5,6,12,13).

The length of each bolt (211-6A,211-6B) sufficiently extends past the front side (4), so that the ends of the bolts (211-6A,211-6B) function as platforms (5,6).

Accordingly the bolt (211-6A,211-6B) ends generally make contact with the surface of the screen (91), therefore, to protect the screen (91) from damage, both ends preferably are filed smooth and or covered in a protective manner including a rubber or vinyl cap placed over the end of each bolt (211-6A,211-6B).

The embodiment shown in FIGS. 14 and 15 rests on the rear side (34) in the same manner as the embodiment shown in FIG. 11.

Additionally, a list of fasteners not previously mentioned, used for joining divided pieces and platforms as one undivided unit includes screws of all types, some mentioned herein; nut of all types, some mentioned herein; solid rivets, rivet screws, open hole rivets, binding post screws, open hole binding posts, clamps, rings, clips, or adhesive hardening substances including polymers and non-polymers, reactive or non-reactive adhesives having one or more parts, and other conventional agents to include glues, contact adhesives, synthetic adhesives, epoxies, rubber cements, silicones or other workable devices and bonding substances not mentioned herein.

Thermo plastic injection molding is a preferred process for making the body as one whole undivided unit and is appropriate for making divided pieces, platforms and components, joined thereafter.

Another preferred process of manufacturing the body as one whole undivided unit and is appropriate for making divided pieces, platforms and components, joined thereafter, is additive manufacturing, frequently referred to as 3D printing, whereby making 3D solid objects using digital data.

As a matter of concern for screen print operators in the print industry, the convention squeegee holder poses several problems, all inherent to the shape of, and lack of elements fundamental to achieving a successful print operation. As mentioned in the Background Section, the position of the handgrip may causes the hands to bend at the adjoining wrist, and due to the narrowness of the grip, pinches the middle palms. As a result, either of these issues may cause musculoskeletal conditions including pain and injury.

Moreover, due to the curved upper portion and the lower flat sides, the conventional holder is unable to brace itself to stand upright or in other supportive positions that minimize blade damage and contamination.

To help solve these issues, advantageous embodiments as described and or shown, including the extensions (2,3) of the upper piece (11) and the support platforms (5,6,12,13,32,33), aid in diminishing the aforementioned problems and conditions that are associated with the conventional squeegee holder.

Although the specifications mentioned, have been described in specific detail with reference to the disclosed embodiments, it is understood, many variations and modifications may be realized within the structure, function, and method of use, as described in the appended claims.

What I claim is:

1. A squeegee blade holder, whereas; the body of the holder has multiple pieces including a lower piece and an upper piece, the upper piece having two hand held extensions; the body includes multiple support platforms; the body and components are made from polymers including plastic and made using processes including thermo injection molding; moreover the extensions and support platforms are utilized to implement multiple methods of use.

2. A squeegee blade holder of claim 1, whereas; the lower piece is common with prior art, characterized by a an oblong shape, having external sides that include one end side, another end side and an elongated mid-section; the linear sides of the mid-section include the front side, rear side, topside and bottom side; the bottom side includes a linear squeegee blade receptacle slot; hereby, subsequent claims refer to the sides of the lower piece described in this claim.

3. A squeegee blade holder of claim 1, whereas; an extension of the upper piece has one end side and another end side, and an elongated mid-section; one end side is joined to another piece and the other end side is not joined.

4. A squeegee blade holder of claim 1, whereas; an extension viewed from the un-joined end side along a linear axis line extending from the un-joined end side to the joined end side, has plan cross sectional views including polygon forms.

5. A squeegee blade holder of claim 1, whereas; an extension viewed from the un-joined end side along a linear axis line extending from the un-joined end side to the joined end side, has plan cross sectional views including curved forms.

6. A squeegee blade holder of claim 1, whereas; viewed from an end side of the lower piece, the linear axis of an extension is straight.

7. A squeegee blade holder of claim 1, whereas; viewed from an end side of the lower piece, the linear axis of an extension includes a curve.

8. A squeegee blade holder of claim 1, whereas; viewed from the front side of the lower piece as the body sets upright, the linear axis of an extension is perpendicular to the horizontal.

9. A squeegee blade holder of claim 1, whereas; viewed from the front side of the lower piece as the body sets upright, the vertical axis of an extension slants in the direction towards the other extension.

10. A squeegee blade holder of claim 1, whereas; viewed from an end side of the lower piece as the body sets upright, the vertical axis of an extension is semi-upright, angled towards the rear side of the lower piece.

11. A squeegee blade holder of claim 1, whereas; viewed from an end side of the lower piece as the body sets upright, the vertical axis of an extension is perpendicular to the horizontal.

12. A squeegee blade holder of claim 1, whereas; an extension includes an inner liner made from rigid materials including metal, encompassed by an outer liner made from rigid materials including a polymer.

13. A squeegee blade holder of claim 1, whereas; an extension includes an inner liner made from rigid materials including polymers, encompassed by an outer liner made from flexible and impact absorbing materials including soft rubber.

14. A squeegee blade holder of claim 1, whereas; a support platform has one end side, another end side, and an elongated mid-section; one end side is joined an extension, the other end side not joined.

15. A squeegee blade holder of claim 1, whereas; the body and components are made using polymer materials including resin, means additive manufacturing, including the making of 3D solid objects using digital data.

16. A squeegee blade holder of claim 1, whereas; pieces, platforms and components are joined means fasteners including screws.

17. A squeegee blade holder of claim 1, whereas; pieces, platforms and components are joined means fasteners including nuts.

18. A squeegee blade holder of claim 1, whereas; pieces, platforms and components are joined means fasteners including hardening adhesives.

19. A squeegee blade holder of claim 1, whereas; a method of use includes pulling or pushing the squeegee blade holder across a screen surface for the purpose of creating an imprint on substrate material means screen printing:
a. An operator holds each extension with one hand, whereby the front side of the lower piece faces the operator.
b. The operator places a blade edge lightly on a screen and pulls or pushes the squeegee blade holder across the surface of the screen at a prescribed angle and with slight downward force, thereby coating the screen with ink, but not allowing ink to pass through the unblocked areas of the screen, thereby preparing the screen for a subsequent print stroke.
c. Next, placing the print edge of the blade on the screen and using a different prescribed angle, again hand holding both extensions, an operator pulls or pushes the squeegee blade holder across the screen.
d. Simultaneously, an operator applies a firm downward pressure, sufficiently forcing ink to pass through the unblocked areas, thereby applying ink to topside of the substrate, thus creating an imprint.

20. A squeegee blade holder of claim 1, whereas; a method of use for the purpose of preventing the elongated mid-section of an extension from contacting a surface as the holder is placed on a surface includes:
a. An operator hand holds both extensions with the front side of the lower piece facing the operator.
b. The operator positions the rear linear edge of the attached blade and the un-joined end side of a support platform towards a surface.
c. Subsequently, the operator places the squeegee blade holder on the surface to rest on the blade edge and the end side of the support platform.

21. A squeegee blade holder whereas; the body of the holder includes a lower piece, a middle piece and an upper piece; the middle piece is bound between a lower and upper piece.

22. A squeegee blade holder of claim 21, whereas; a middle piece and an extension of the upper piece are made as an undivided unit, thereafter joined to the lower piece.
